(19) United States
(12) Patent Application Publication
(10) Pub. No.: US 2024/0114206 A1
(43) Pub. Date: Apr. 4, 2024

(54) Variable Concurrent Access to Content of a Device by Multiple Devices

(71) Applicant: Motorola Mobility LLC, Chicago, IL (US)

(72) Inventors: Amit Kumar Agrawal, Bangalore (IN); Wendel Malta de Assis, Campinas (BR); Andre Luiz Silva Bazante, Campinas (BR)

(73) Assignee: Motorola Mobility LLC, Chicago, IL (US)

(21) Appl. No.: 17/958,051

(22) Filed: Sep. 30, 2022

(51) Int. Cl. H04N 21/454; H04N 21/41; H04N 21/475

(52) U.S. Cl. CPC H04N 21/454; H04N 21/4104; H04N 21/4751

(57) ABSTRACT

In aspects of variable concurrent access to content of a device by multiple devices, content of a primary device is detected as being accessed concurrently by a primary user via the primary device and by a secondary user via a secondary device communicatively coupled to the primary device. Unrestricted access to the content of the primary device is provided to the primary device and restricted access to the content of the primary device is provided to the secondary device. The restricted access prevents the secondary user from accessing a subset of the content of the primary device. A first portion of the content of the primary device is output via the primary device. Further, a second portion of the content of the primary device is caused to be output by the secondary device while the primary device outputs the first portion of the content.

### BACKGROUND

As technology has advanced, electronic devices have become increasingly powerful and capable of performing a multitude of tasks. For instance, some electronic devices include a content redirection feature enabling content of an electronic device to be output to a connected device, such as a television or desktop monitor. This allows the user to view the display of their electronic device on the typically much larger display of the connected device.

### BRIEF DESCRIPTION OF THE DRAWINGS

Aspects of variable concurrent access to content of a device by multiple devices are described with reference to the following Figures. The same numbers may be used throughout to reference similar features and components that are shown in the Figures. Further, identical numbers followed by different letters reference different instances of features and components described herein:

FIG. 1 illustrates an example environment in which aspects of variable concurrent access to content of a device by multiple devices can be implemented;

FIG. 2 depicts an example system in which aspects of variable concurrent access to content of a device by multiple devices can be implemented to provide unrestricted access to a primary device and restricted access to a secondary device;

FIG. 3 depicts an example system in which aspects of variable concurrent access to content of a device by multiple devices can be implemented to provide restricted access to a primary device and unrestricted access to a secondary device;

FIGS. 4A and 4B depict an example showing that the unrestricted access includes functionality to remotely access content being output by another device;

FIG. 5 depicts an example procedure of variable concurrent access to content of a device by multiple devices to provide unrestricted access to a primary device and restricted access to a secondary device;

FIG. 6 depicts an example procedure of variable concurrent access to content of a device by multiple devices to provide restricted access to a primary device and unrestricted access to a secondary device;

FIG. 7 illustrates various components of an example device that can implement aspects of variable concurrent access to content of a device by multiple devices.

### DETAILED DESCRIPTION

Variable concurrent access to content of a device by multiple devices is discussed herein. For example, a primary user (e.g., an owner) of a primary device may directly access content of the primary device. Further, a secondary user (e.g., a registered guest user) may also access the content of the device via a secondary device communicatively coupled to the primary device. In some scenarios, the primary user may wish to access content of the primary device and concurrently share content of the primary device with the secondary device to be accessed by the secondary user. In doing so, the primary user may also wish to prevent the secondary user from accessing private, secure, or age-inappropriate content. However, this is typically not possible for conventional techniques which simply provide the same level of access to multiple devices in a content sharing environment.

Thus, in aspects of the described techniques, a content control module is implemented to provide, to the primary device, unrestricted access to the content of the primary device being accessed by the primary user. Concurrently, the content control module provides, to the secondary device, restricted access to the content of the primary device. Initially, a subset of the content of the primary device is specified (e.g., by the primary user) as restricted content, which the secondary user is prevented from accessing. The restricted content, for instance, includes applications of the primary device, portions of content that are accessible via applications of the primary devices, user-generated content maintained in memory, and so on.

In response to detecting content of the primary device being accessed concurrently via the primary device and the secondary device, the content control module determines which user is accessing which device. In one or more implementations, the content control module determines that the primary user is accessing the primary device and the secondary user is accessing the secondary device. In such implementations, the content control module is configured to provide unrestricted access to the primary device permitting the primary user to access the content of the primary device without restriction. Moreover, the content control module is configured to provide restricted access to the secondary device, which enables the secondary user to access some content of the primary device while preventing the secondary user from accessing the restricted content.

While operating in the different access modes, the primary device and the secondary device are configured to concurrently access different content. By way of example, while operating in the unrestricted access mode, the primary device is configured to output a first portion of the content of the primary device, which may or may not be a part of the restricted content. Concurrently, while operating in the restricted access mode, the secondary device is configured to output a second portion of the content of the primary device that is not a part of the restricted content. Notably, the first portion of the content and the second portion of the content are independently manipulable via the primary device and the secondary device, respectfully. In other words, the primary user can manipulate and alter the first portion of the content output via the primary device without affecting the second portion of the content output via the secondary device, and vice versa.

In some implementations, the content control module determines that the primary device is being accessed by the secondary user (e.g., rather than the primary user) and the secondary device is being accessed by the primary user, e.g., rather than the secondary user. In such implementations, the content control module provides the restricted access to the primary device (e.g., rather than the secondary device), and provides the unrestricted access to the secondary device, e.g., rather than the primary device.

Thus, the described techniques enable content of the primary device to be accessed concurrently by multiple different devices, which are each configured to operate in different access modes. By doing so, the primary user can access the full content of the primary device, concurrently share the content of the primary device with the secondary user accessing the content via a different device, and prevent the secondary user from accessing private, secure, or age-inappropriate content.

While features and concepts of the described techniques for variable concurrent access to content of a device by multiple devices can be implemented in any number of different devices, systems, environments, and/or configurations, implementations of the techniques for variable concurrent access to content of a device by multiple devices are described in the context of the following example devices, systems, and methods.

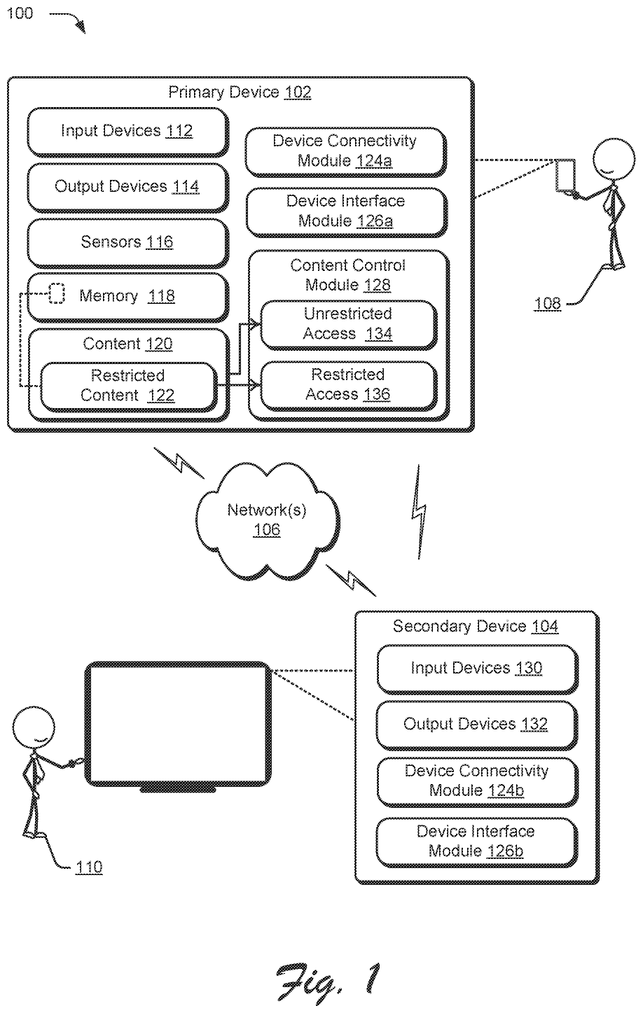

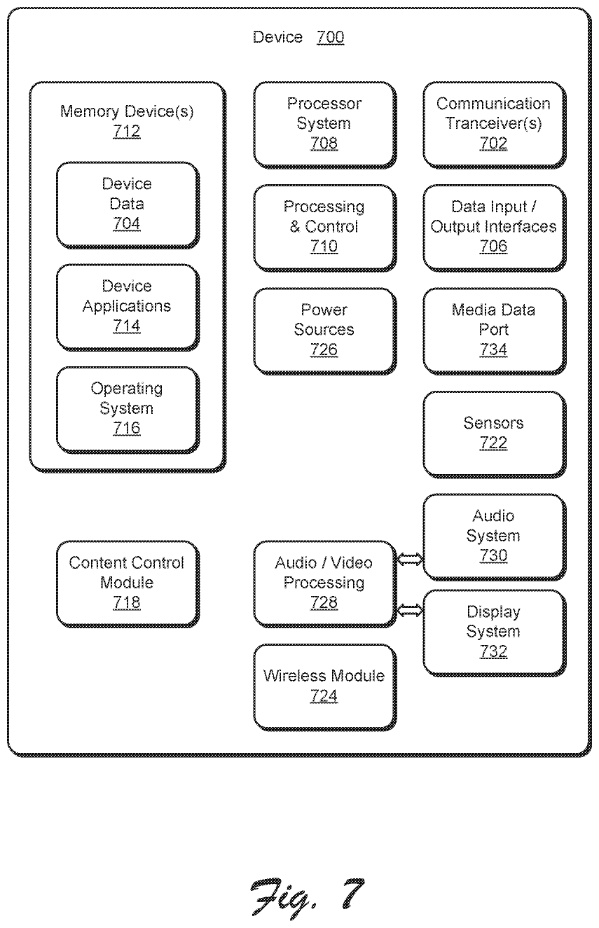

FIG. 1 illustrates an example environment 100 in which aspects of variable concurrent access to content of a device by multiple devices can be implemented. The environment 100 includes a primary device 102 and a secondary device 104 that are interconnectable in various ways to enable content of the primary device 102 to be output concurrently by both the primary device 102 and the secondary device 104. The primary device 102 and the secondary device 104, for instance, are interconnectable via one or more networks 106 and/or via direct inter-device connectivity, e.g., via direct wireless and/or wired connectivity between the primary device 102 and the secondary device 104. In this particular example, the primary device 102 represents a mobile device being accessed by a primary user 108 while the secondary device 104 represents an external display device, such as a television or desktop monitor, being accessed by a secondary user 110. The primary user 108, for instance, represents an owner or manager of the primary device 102 while the secondary user 110 represents a registered guest user of the primary device 102. These examples are not to be construed as limiting, however, and the primary device 102 and/or the secondary device 104 can be implemented in a variety of different ways and form factors, examples of which include a mobile phone, a tablet, a smart television set (e.g., a smart TV), a personal desktop computer, a personal laptop computer, a television monitor, a desktop monitor, and a wearable device such as a smartwatch, augmented reality/virtual reality glasses, flexible smart glasses, and so on. Example attributes of the primary device 102 and the secondary device 104 are discussed below with reference to device 700 of FIG. 7.

The primary device 102 includes various functionality that enables the primary device 102 to perform different aspects of variable concurrent access to content of a device by multiple devices discussed herein, including input devices 112, output devices 114, sensors 116, memory 118 to maintain content 120 that includes restricted content 122, a device connectivity module 124a, a device interface module 126a, and a content control module 128. The input devices 112 represent functionality for enabling input to the primary device 102, such as user input to invoke functionality of the primary device 102. The input devices 112 can be implemented in various ways, including a touch sensitive display screen to receive touch input, a microphone to receive audible input (e.g., speech), a physical keyboard to receive text input, and so forth. The output devices 114 represent functionality for enabling output of content via the primary device 102, such as for consumption by the primary user 108. The output devices 114 can be implemented in various ways, including a display device to output visual content (e.g., video data, display data, image data, etc.), an audio system to output audio data, and so forth.

The sensors 116 represent functionality to collect sensor data for detecting the presence of and/or ascertaining the identity of a user accessing the primary device 102, e.g., to determine that the user accessing the primary device 102 is the primary user 108. The sensors 116 can be implemented in various ways, including presence sensors, biometric sensors (e.g., to enable facial recognition, fingerprint recognition, iris recognition, etc.), proximity sensors, (e.g., to determine proximity of a user to the primary device 102, to determine proximity of a wearable device associated with a user to the primary device 102, etc.), a microphone (e.g., to enable voice recognition), etc.

The content 120 is maintained in the memory 118 of the primary device 102 and includes applications of the primary device 102 (e.g., streaming applications, gaming applications, word processing applications, content generation applications, spreadsheet applications, web-browsing applications, etc.), content that is accessible via the applications (e.g., individual pieces of media or categories of media accessible via a streaming application, websites accessible via a browsing application), user generated content stored in the memory 118 (e.g., documents, folders of documents, photo libraries, etc.), and so forth. The content 120 includes restricted content 122 which represents a subset of the content 120 which is inaccessible to the secondary user 110. In various examples, the restricted content 122 is specified by the primary user 108, e.g., via device settings of the primary device 102 or application settings of a content sharing application that implements the content control module 128. In one or more implementations, there is more than one secondary user 110 of the primary device 102, and as such, there is more than one set of restricted content—one for each secondary user 110 of the primary device 102.

The device connectivity module 124a represents functionality (e.g., logic and hardware) for enabling the primary device 102 to interconnect with other devices and/or networks, such as the secondary device 104 and the wireless network(s) 106. The device connectivity module 124a, for instance, enables wireless and/or wired connectivity of the primary device 102. The device interface module 126a represents functionality for enabling the primary device 102 to interface with other devices. As further discussed below, for instance, the device interface module 126a enables the primary device 102 to establish wireless and/or wired data communication with other devices, e.g., the secondary device 104.

Each of the device connectivity module 124a, the device interface module 126a, and the content control module 128 can be implemented in a variety of different manners. For example, each of the modules 124a, 126a, and 128 can be implemented as multiple instructions stored on computer-readable storage media which can be executed by a processor system of the primary device 102. Additionally or alternatively, each of the modules 124a, 126a, and 128 can be implemented at least partially in hardware (e.g., as an application-specific integrated circuit (ASIC), a field-programmable gate array (FPGA), an application-specific standard product (ASSP), a system-on-a-chip (SoC), a complex programmable logic device (CPLD), and so forth). One or more of the of the modules 124a, 126a, and 128 can be implemented in the same manner, or modules 124a, 126a, and 128 can each be implemented in a different manner.

The secondary device 104 includes various functionality that enables the secondary device 104 to perform different aspects of variable concurrent access to content of a device by multiple devices discussed herein, including input devices 130, output devices 132, a device connectivity module 124b, and a device interface module 126b. The input devices 130 represent functionality for enabling input to the secondary device 104 (e.g., user input to control the content 120 of the primary device 102 being output by the secondary device 104) and are implementable in various ways, similar to the input devices 112. The output devices 132 represent functionality for enabling output of content via the secondary device 104 (e.g., to output the content 120 of the primary device 102 via the secondary device 104 for consumption by the secondary user 110) and are implementable in various ways, similar to the output devices 114. In various scenarios, the secondary device 104 also includes sensors to ascertain the identity of a user accessing the secondary device 104 (e.g., to determine that the user accessing the secondary device 104 is the secondary user 110). In accordance with these scenarios, the sensors of the secondary device 104 are implementable in various ways, similar to the sensors 116.

The device connectivity module 124b represents functionality (e.g., logic and hardware) for enabling the secondary device 104 to interconnect with other devices and/or networks, such as the primary device 102 and the network(s) 106. The device connectivity module 124b, for instance, enables wireless and/or wired connectivity of the secondary device 104.

The device interface module 126b represents functionality for enabling the secondary device 104 to interface with other devices. Generally, the device interface module 126a and the device interface module 126b interface to establish data connectivity between the primary device 102 and the secondary device 104. In accordance with the described techniques, the data connectivity is implemented via wireless and/or wired connectivity between the primary device 102 and the secondary device 104 for exchanging data between the devices. The data connectivity, for instance, is implemented via direct wireless and/or wired connectivity between the primary device 102 and the secondary device 104, and/or via data communication over the network(s) 106 between the primary device 102 and the secondary device 104. In one or more implementations, the data connectivity is implemented via a variety of different wireless protocols, such as wireless cellular (e.g., 3G, 4G, 5G), wireless broadband, Wireless Local Area Network (WLAN) (e.g., Wi-Fi), Wi-Fi Direct, wireless short distance communication (e.g., Bluetooth™ (including Bluetooth™ Low Energy (BLE)), Near Field Communication (NFC)), and so forth.

Each of the device connectivity module 124b and the device interface module 126b can be implemented in a variety of different manners. For example, each of the modules 124b and 126b can be implemented as multiple instructions stored on computer-readable storage media that can be executed by a processor system of the secondary device 104. Additionally or alternatively, each of the modules 124b and 126b can be implemented at least in part in hardware (e.g., as an ASIC, an FPGA, an ASSP, an SoC, a CPLD, and so forth). One or more of the of the modules 124b and 126b can be implemented in the same manner, or modules 124b and 126b can each be implemented in a different manner.

According to implementations for variable concurrent access to content of a device by multiple devices, the device interface module 126a of the primary device 102 interfaces with the device interface module 126b of the secondary device 104 to communicate the content 120 of the primary device 102 to the secondary device 104 for output. In at least one example, the device interface modules 126a, 126b enable the primary user 108 to access a first portion of the content 120 via the primary device 102 while the secondary user 110 accesses a second portion of the content 120 via the secondary device 104. In some implementations, the first portion of the content 120 that is output by the primary device 102 is different than the second portion of the content 120 that is output by the secondary device 104. Moreover, the first portion of the content 120 that is output by the primary device 102 can be manipulated via the input devices 112 of the primary device 102 without altering the second portion of the content 120 that is output by the secondary device 104. Similarly, the second portion of the content 120 that is output by the secondary device 104 can be manipulated via the input devices 130 without altering the first portion of the content 120 that is output by the primary device 102.

In accordance with the described techniques, the content control module 128 detects the content 120 of the primary device 102 being accessed concurrently by the primary user 108 via the primary device 102 and by the secondary user 110 via the secondary device 104. Given this, the content control module 128 provides unrestricted access 134 to the primary device 102 which causes the primary device 102 to operate in an unrestricted access mode. In the unrestricted access mode, the full content 120 of the primary device 102 is accessible via the primary device 102 without restrictions. Further, the content control module 128 provides restricted access 136 to the secondary device 104 which causes the secondary device 104 to operate in a restricted access mode. In the restricted access mode, the restricted content 122 is inaccessible via the secondary device 104, but at least a portion of the content 120 (e.g., content 120 that is not included as part of the restricted content 122) is accessible via the secondary device 104. While the primary device 102 and the secondary device 104 operate in different access modes, the devices 102, 104 are each configured to concurrently output different content of the primary device 102. For example, the content control module 128 outputs a first portion of the content 120 via the primary device 102 and communicates a second portion of the content 120 to be output concurrently by the secondary device 104.

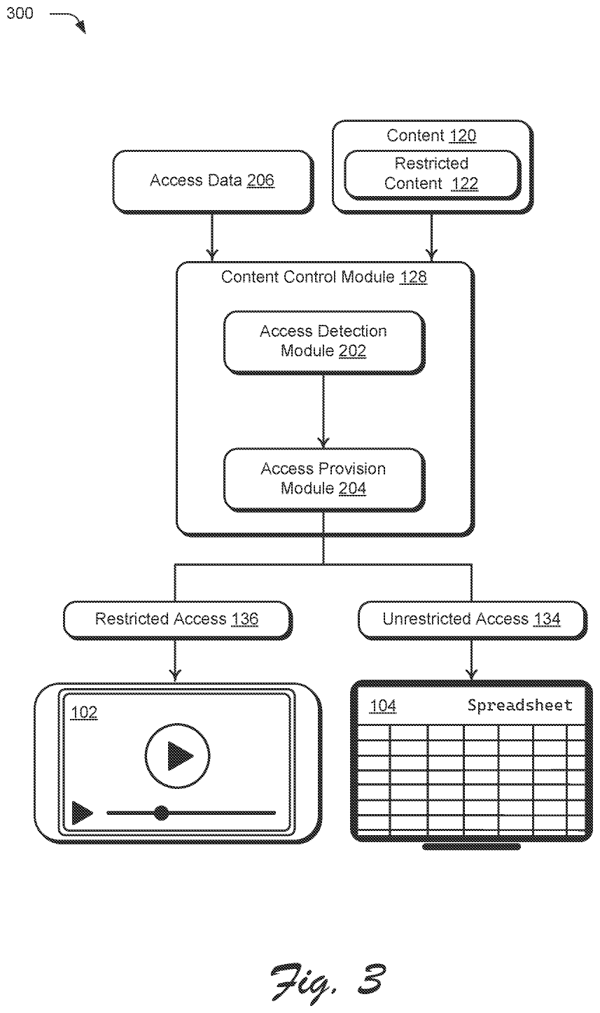

In variations, the content control module 128 detects the content 120 of the primary device 102 being accessed by the primary user 108 via the secondary device 104, rather than the primary device 102. At the same time, the content control module 128 detects the content 120 being accessed by the secondary user 110 via the primary device 102, rather than the secondary device 104. In accordance with these variations, the content control module 128 provides the unrestricted access 134 to the secondary device 104 and provides the restricted access 136 to the primary device 102, as further discussed below with reference to FIG. 3.

Conventional techniques to share content of a device simply provide the same level of access to multiple devices accessing content of one device. Alternatively, conventional techniques provide multiple levels of access to one device but do so at different times depending on the user accessing the one device. For example, conventional techniques provide different levels of access to users logged in to different user accounts of one device at different times. In contrast, the described techniques enable content 120 of the primary device 102 to be accessed via the primary device 102 in an unrestricted access mode while content of the primary device 102 is accessed via the secondary device 104 in a restricted access mode. By doing so, the primary user 108 can access the full content 120 of the primary device 102. At the same time, the secondary user 110 can access different content 120 of the primary device 102 via the secondary device 104, while concurrently being prevented from accessing the restricted content 122, which is not possible in conventional techniques.

Having discussed an example environment in which the disclosed techniques can be performed, consider now some example scenarios and implementation details for implementing the disclosed techniques.

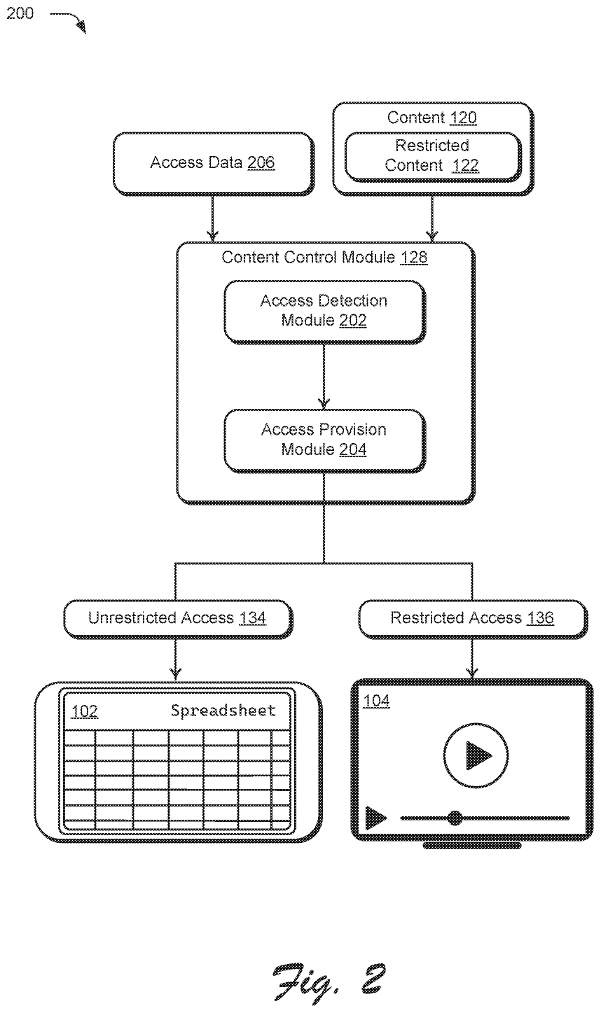

FIG. 2 depicts an example system 200 in which aspects of variable concurrent access to content of a device by multiple devices can be implemented to provide unrestricted access to a primary device and restricted access to a secondary device. The system 200 includes the content control module 128, an access detection module 202, and an access provision module 204. Generally, the content control module 128 is configured to provide the unrestricted access 134 to the primary device 102 being accessed by the primary user 108, and to provide the restricted access 136 to the secondary device 104 being accessed by the secondary user 110.

More specifically, the access detection module 202 includes functionality to detect that the content 120 of the primary device 102 is being accessed concurrently via the primary device 102 and via the secondary device 104. By way of example, the access detection module 202 determines that the primary device 102 is communicating content 120 for output by the output devices 132 of the secondary device 104, e.g., as part of a content sharing application. Moreover, the access detection module 202 determines that the primary device 102 itself is simultaneously outputting content 120 via the output devices 114.

The access detection module 202 further includes functionality to determine which user is accessing the content 120 via the primary device 102 and which user is accessing the content 120 via the secondary device 104. In the example system 200, for instance, the access detection module 202 determines that the primary user 108 is accessing the content 120 via the primary device 102 while the secondary user 110 is accessing the content 120 via the secondary device 104. To do so, the access detection module 202 receives access data 206 from the primary device 102 and/or the secondary device 104. The access data 206, for example, includes sensor data obtained from the sensors 116 of the primary device 102, sensor data obtained from the sensors of the secondary device 104, a device signature associated with a wearable device of the primary user, a device signature associated with a wearable device of the primary user, etc. Generally, the access detection module 202 is configured to compare collected access data 206 to stored access data associated with the primary user 108 and/or the secondary user 110 and determine which user is accessing the primary device 102 and which user is accessing the secondary device 104.

In one example, the access detection module 202 determines that the primary device 102 is being accessed by the primary user 108 based on access data 206 in the form of sensor data (e.g., biometric data, voice data, etc.) received from the sensors 116 and identifying the primary user 108. Additionally or alternatively, the access detection module 202 determines that the secondary device 104 is being accessed by the secondary user 110 based on access data 206 in the form of sensor data (e.g., biometric data, voice data) received from sensors of the secondary device 104 and identifying the secondary user 110.

In another example, the access detection module 202 determines that the primary device 102 is being accessed by the primary user 108 based on access data 206 in the form of authentication data (e.g., a password, a PIN, etc.) received from the input devices 112 of the primary device 102 and identifying the primary user 108. Additionally or alternatively, the access detection module 202 determines that the secondary device 104 is being accessed by the secondary user 110 based on access data 206 in the form of authentication data (e.g., a password, a PIN, etc.) received from the input devices 130 of the secondary device 104.

In another example, the access detection module 202 receives the access data 206 in the form of multiple device signatures—a device signature identifying a wearable device associated with the primary user 108 and a device signature identifying a wearable device associated with the secondary user 110. In this example, the access detection module 202 determines that the primary user 108 is accessing the primary device 102 and the secondary user 110 is accessing the secondary device 104 based on the wearable device of the primary user 108 being closer to the primary device 102 than the wearable device of the secondary user 110.

In some scenarios, the wearable device associated with the primary user 108 and the wearable device associated with the secondary user 110 are both detected within a threshold radius of the primary device 102. In other scenarios, only one wearable device is detected, e.g., a wearable device associated with the primary user 108 or a wearable device associated with the secondary user 110. In such scenarios, it is uncertain which user 108, 110 is accessing which device 102, 104 based solely on wearable device proximity data. Thus, in the scenarios listed above, the access detection module 202 invokes sensors and/or input devices of the primary device 102 and/or the secondary device 104 to capture additional access data 206 (e.g., in the form of biometric data, voice data, authentication data, etc.) to determine which user is accessing the primary device 102 and which user is accessing the secondary device 104, as discussed above.

In accordance with the described techniques, the access provision module 204 receives an indication of which user is accessing the primary device 102 and which user is accessing the secondary device 104 from the access detection module. In the illustrated example, for instance, the access provision module 204 receives an indication that the content 120 of the primary device 102 is being accessed by the primary user 108 via the primary device 102 and simultaneously by the secondary user 110 via the secondary device 104.

Furthermore, the access provision module 204 receives an indication of the content 120 of the primary device 102 and the restricted content 122 that the secondary user 110 is prevented from accessing. To do so, the content control module 128 initially receives user input (e.g., via a device settings user interface of the primary device 102 or via an application settings user interface of a content sharing application that implements the content control module 128) specifying the restricted content 122. Thus, in response to detecting simultaneous access to the primary device 102 and the secondary device 104 by different users, the access provision module 204 retrieves the indication of the content 120 and the restricted content 122 from the memory 118.

In various examples, the restricted content 122 includes applications of the primary device 102, portions of content that are accessible via the applications of the primary device 102 (e.g., individual pieces of media or categories of media accessible via a streaming application, websites that are accessible via a browsing application), an operational mode for an application (e.g., the restricted content 122 includes all streaming contents of a streaming application that are not included in a kids mode), user generated content, e.g., individual photos, videos, documents maintained in the memory 118, or folders of photos, videos, and/or documents maintained in the memory 118. In one or more implementations, the content 120 also includes temporal restrictions on the content 120 that is accessible by the secondary user 110. The temporal restrictions, for instance, prevent the secondary user 110 from accessing the content 120 of the primary device for longer than a time limit specified by the primary user 108. Additionally or alternatively, the temporal restrictions prevent the secondary user 110 from accessing a portion of the content 120 (e.g., a specific application or a category of applications, such as gaming applications or streaming applications) for longer than a time limit specified by the primary user 108.

Based on the content 120 of the primary device 102 being concurrently accessed by the primary user 108 via the primary device 102 and by the secondary user 110 via the secondary device 104, the access provision module 204 provides the unrestricted access 134 to the primary device 102 and provides the restricted access 136 to the secondary device 104. The restricted access 136 prevents the secondary user 110 from accessing the restricted content 122 via the secondary device 104. However, the content 120 of the primary device 102 that is not included in the restricted content 122 is accessible by the secondary user 110 via the secondary device 104. In one or more implementations, the restricted access 136 provided to the secondary device 104 permits the secondary user 110 to access the content 120 of the primary device 102 in accordance with the specified temporal restrictions. In one example, for instance, providing the restricted access 136 to the secondary device 104 includes enabling a streaming application of the primary device 102 to be accessed and executed in a kid's mode, but only for a specified amount of time.

The access provision module 204 can provide the restricted access 136 to the secondary device 104 in a variety of ways. Consider an example in which the restricted content 122 includes an application of the primary device 102. In this example, an icon of the restricted application can be removed from the user interface of the secondary device 104. Additionally or alternatively, user inputs to access the application are ignored. For example, user input to input search terms relating to the application using a search feature of the secondary device 104 is not effective to display or otherwise access content of the application. Moreover, notifications associated with the restricted application are prevented from being displayed in a user interface of the secondary device 104, though the notifications associated with the restricted application are displayed in a user interface of the primary device 102.

In another example, the restricted content 122 includes only a portion of application content, e.g., rated R movies in a streaming application. In this example, the icon of the application is displayable and selectable via the user interface of the secondary device 104. However, the restricted content 122 (e.g., the rated R movies) of the application is removed from the user interface of the application displayed on the secondary device 104. Additionally or alternatively, inputs to access the restricted content 122 of the application (e.g., via a search feature of the restricted application) are ignored.

In yet another example, operating in the restricted access mode includes enabling an application of the primary device 102 to be accessed via the secondary device 104 subject to a temporal restriction. In this example, the icon of the application is displayable and selectable via the user interface of the secondary device 104. However, responsive to the application being accessed via the secondary device 104, a notification is displayed in the user interface of the secondary device 104 indicating the time limit for accessing the application. Further, once the time limit is reached, the access provision module 204 automatically disables the application, and treats the application as if it is a part of the restricted content 122, e.g., the application is removed from the user interface of the secondary device 104, inputs to access the application are ignored, and notifications associated with the application are prevented from being displayed.

In accordance with the described techniques, the unrestricted access 134 permits the primary user 108 to access the full content 120 via the primary device 102 without restrictions. In other words, the content 120 of the primary device 102 can be accessed via the primary device 102 regardless of the content 120 that is concurrently being accessed via the secondary device 104.

In one or more implementations, the content 120 includes content that is designated by the primary user 108 as restricted content 122, content that is designated by the primary user 108 as accessible content (e.g., content 120 that is accessible by the secondary user 110), and content that has not yet been designated. In accordance with these implementations, operating the primary device 102 in the unrestricted access mode includes displaying a notification in a user interface of the primary device 102 in response to undesignated content (e.g., a recently downloaded application) being accessed via the secondary device 104. Notably, the notification includes a first user interface element selectable to permit the secondary user 110 to access the undesignated content 120 via the secondary device 104 and a second user interface element selectable to prevent the secondary user 110 from accessing the undesignated content 120 via the secondary device 104. In response to the first user interface element being selected, the undesignated content is automatically maintained in the memory 118 as accessible content for subsequent accesses to the undesignated application by the secondary user 110. In response to the second user interface element being selected, the undesignated content is maintained in the memory 118 as restricted content 122 for subsequent accesses to the undesignated content 120 by the secondary user 110.

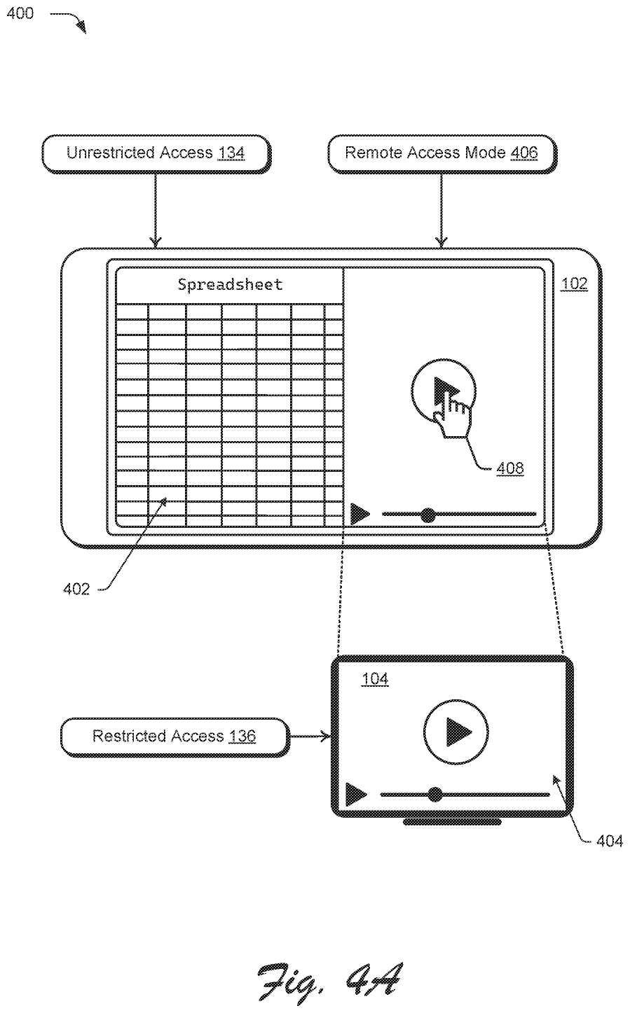

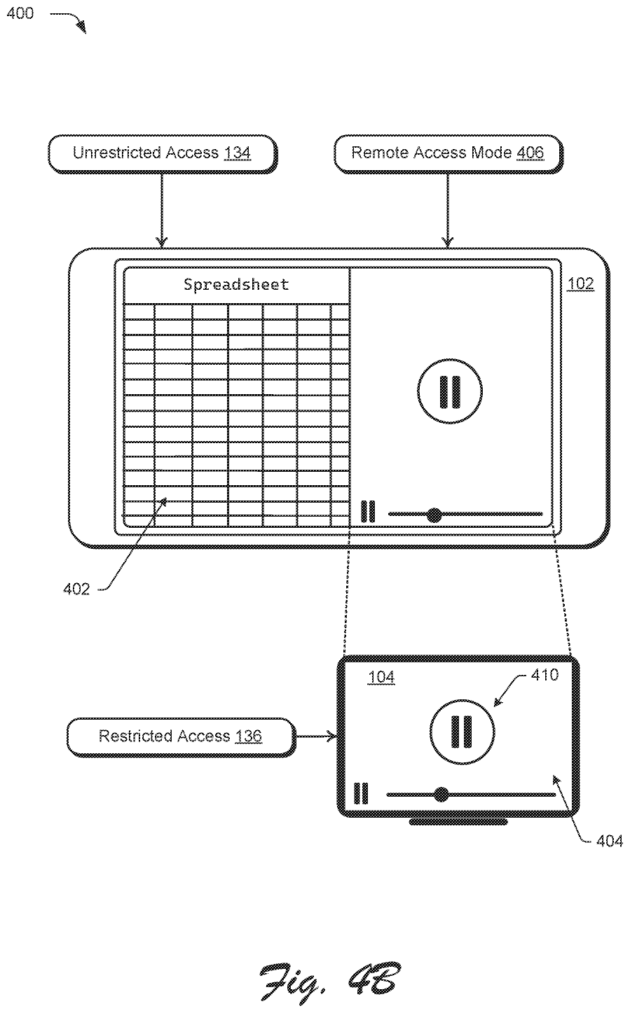

In various examples, the access provision module 204 receives an indication of an attempt to access content 120 for which a temporal restriction has already been imposed. In this example, operating the primary device 102 in the unrestricted access mode includes displaying a notification in a user interface of the primary device 102 in response to the attempt to access the content 120. Notably, the notification includes a user interface element that is selectable to override the temporal restriction and enable the user to access the content 120 as well as an additional user interface element to decline to override the temporal restriction. As further discussed with reference to FIGS. 4A and 4B, the unrestricted access 134 provided to the primary device 102 also includes an option to enter in a remote access mode.

In accordance with the described techniques, the content control module 128 causes a first portion of the content 120 to be output by the primary device 102 operating in the unrestricted access mode while a second portion of the content 120 is output by the secondary device 104 operating in the restricted access mode. In some examples, the first portion of the content 120 and the second portion of the content 120 are different. Indeed, as shown in the example system 200, the first portion of the content 120 output by the primary device 102 is a first application of the primary device 102 (e.g., a spreadsheet application) while the second portion of the content 120 output by the secondary device 104 is a second application of the primary device 102, e.g., a streaming application. In some implementations, the first portion of the content 120 output by the primary device 102 is restricted content 122 that is not accessible via the secondary device 104 operating in the restricted access mode.

Notably, the first portion of the content 120 is independently manipulable via the primary device 102 and the second portion of the content 120 is independently manipulable via the secondary device 104. Consider the illustrated example in which the primary user 108 is accessing a spreadsheet application via the primary device 102 and the secondary user 110 is accessing a streaming application via the secondary device 104. In this example, the streaming application executes on the secondary device 104 independently of the spreadsheet application executing on the primary device 102, and vice versa. In other words, the secondary user 110 can manipulate the content of the streaming application via the input devices 130 of the secondary device 104 without affecting the content 120 output via the primary device 102. Additionally or alternatively, the primary user 108 can manipulate the content of the spreadsheet application without affecting the content 120 output via the secondary device 104.

Accordingly, the content control module 128 is configured to cause the secondary device 104 to operate in the restricted access mode while the primary device 102 operates in the unrestricted access mode. While operating in different access modes, the primary user 108 and the secondary user 110 can simultaneously access and independently manipulate different content 120 of the primary device 102 via the primary device 102 and the secondary device 104, respectively.

Consider an example in which the primary user 108 is a parent and the secondary user 110 is a child of the parent. In accordance with this example, the parent can access the full content 120 of the primary device 102 via the primary device 102. Further, the parent can enable the child to access the content 120 of the primary device 102 via the secondary device 104 while preventing the child from accessing the restricted content 122. In other words, both the parent and the child can concurrently access the content 120 of the primary device 102, with the parent accessing the content 120 via the primary device 102 in an unrestricted access mode, and with the child accessing the content 120 via the secondary device 104 in a restricted access mode. This is not possible for conventional techniques which simply provide different access levels to different users accessing a device at different times, e.g., via different user accounts.

FIG. 3 depicts an example system 300 in which aspects of variable concurrent access to content of a device by multiple devices can be implemented to provide restricted access to a primary device and unrestricted access to a secondary device. In this example, the content control module 128 is configured to provide the restricted access 136 to primary device 102 being accessed by the secondary user 110, and to provide the unrestricted access 134 to the secondary device 104 being accessed by the primary user 108.

Generally, the access detection module 202 includes the features discussed above with reference to FIG. 2. However, in this example, the access detection module 202 determines that the secondary user 110 is accessing the content 120 via the primary device 102 and the primary user 108 is accessing the content 120 via the secondary device 104. In one or more implementations, the access detection module 202 detects a change in device access in a same access session. For example, the access detection module 202 initially detects the primary user 108 accessing the content 120 via the primary device 102 and the secondary user 110 accessing the content 120 via the secondary device 104. Furthermore, the access detection module 202 periodically collects the access data 206 for comparison to the stored access data. Based on the periodically collected access data 206, the access detection module 202 detects a change in device access, e.g., indicating that the primary device 102 is now being accessed by the primary user 108 and/or indicating that the secondary device 104 is now being accessed by the secondary user 110.

In accordance with the described techniques, the access provision module 204 receives an indication of the change in device access from the access detection module 202. Generally, the access provision module 204 includes the features discussed above with reference to FIG. 2 However, based on the detected change in device access, the access provision module 204 is configured to provide the restricted access 136 to the primary device 102 which causes the primary device 102 to operate in the restricted access mode. In the restricted access mode, the restricted content 122 is inaccessible via the primary device 102, but at least a portion of the content (e.g., content that is not included as part of the restricted content 122) is accessible via the primary device 102 and in accordance with any specified temporal restrictions. Further, the access provision module 204 is configured to provide the unrestricted access 134 to the secondary device 104 which causes the secondary device 104 to operate in the unrestricted access mode. In the unrestricted access mode, the full content 120 of the primary device 102 is accessible via the secondary device 104 without restrictions.

In one or more implementations, the content control module 128 causes a first portion of the content 120 to be output by the secondary device 104 operating in the unrestricted access mode while a second portion of the content 120 is output by the primary device 102 operating in the restricted access mode. In implementations, the first portion of the content 120 and the second portion of the content 120 are different. Indeed, as shown in the example system 300, the first portion of the content 120 output by the secondary device 104 is a first application of the primary device 102 (e.g., a spreadsheet application) while the second portion of the content 120 output by the primary device 102 is a second application of the primary device 102, e.g., a streaming. In some implementations, the first portion of the content 120 output by the secondary device 104 operating in the unrestricted access mode is restricted content 122 that is not accessible via the primary device 102 operating in the restricted access mode.

In one or more implementations, the access detection module 202 detects one of the devices 102, 104 being accessed by multiple different users. In scenarios in which at least one of the multiple users is the primary user 108, the access provision module 204 provides the unrestricted access 134 to the device being accessed. In scenarios in which each of the multiple users are secondary users 110, the access provision module 204 provides the restricted access 136 to the device being accessed. However, the restricted access 136 provided to the device being accessed includes the restricted content 122 and/or temporal restrictions for each of the secondary users 110 accessing the device.

Consider an example in which a first set of restricted content 122 is specified for a secondary user 110 and includes a spreadsheet application, but not a streaming application. Further, a second set of restricted content 122 is specified for an additional secondary user 110 and includes the streaming application, but not the spreadsheet application. In response to detecting the secondary user 110 and the additional secondary user 110 accessing the secondary device 104, the restricted access 136 prevents the secondary users 110 from accessing the spreadsheet application and the streaming application. In other words, the access provision module 204 combines the restricted content 122 for each of the secondary users 110 accessing the device.

Accordingly, the content control module 128 is configured to cause the primary device 102 to operate in the restricted access mode while the secondary device 104 operates in the unrestricted access mode. While operating in different access modes, the primary user 108 and the secondary user 110 can simultaneously access and independently manipulate different content 120 of the primary device 102 via the secondary device 104 and the primary device 102, respectively.

Continuing with the previous example in which the primary user 108 is a parent and the secondary user 110 is a child of the parent, the parent can access the full content 120 of the primary device 102 via the secondary device 104. Further, the parent can enable the child to access the content 120 of the primary device 102 via the primary device 102 while preventing the child from accessing the restricted content 122. In other words, both the parent and the child can concurrently access the content 120 of the primary device 102, with the parent accessing the content 120 via the secondary device 104 in an unrestricted access mode, and with the child accessing the content 120 via the primary device 102 in a restricted access mode. This is not possible for conventional techniques which simply provide different access levels to different users accessing a device at different times, e.g., via different user accounts.

FIGS. 4A and 4B depict an example 400 showing that the unrestricted access includes functionality to remotely access content being output by a different device. In the example 400, the access provision module 204 provides the unrestricted access 134 to the primary device 102 being accessed by the primary user 108. Further, the access provision module 204 provides the restricted access 136 to the secondary device 104 being accessed by the secondary user 110. Moreover, a first portion 402 of the content 120 is being accessed via the primary device 102 while a second portion 404 of the content 120 is being accessed via the secondary device 104.

In accordance with the described techniques, the content control module 128 receives user input from the input devices 112 of the primary device 102 to enter into a remote access mode 406, e.g., via a user interface element of a content sharing application that runs the content control module 128. In one or more implementations, only the device that is operating in the unrestricted access mode can enter into the remote access mode 406. Thus, in the illustrated example 400, the primary device 102 can enter into the remote access mode 406, but the secondary device 104 cannot. In other scenarios in which the secondary device 104 is operating in the unrestricted access mode and the primary device 102 is operating in the restricted access mode, the secondary device 104 can enter into the remote access mode 406, but the primary device 102 cannot. Given this, although example 400 is depicted and discussed below with respect to the primary device 102 entering into the remote access mode 406 to remotely access and control the content output via the secondary device 104, it is to be appreciated that the secondary device 104 can similarly enter into the remote access mode 406 to remotely access and control content output via the primary device 104 without departing from the spirit or scope of the described techniques.

In response to receiving the user input to enter into the remote access mode 406, the content control module 128 outputs, via the output devices 114 of the primary device 102, the second portion 404 of the content 120 that is currently being output by the secondary device 104. In addition, the primary device 102 simultaneously outputs the first portion 402 of the content 120. In some implementations, the primary device 102 is configured to concurrently output the first portion 402 of the content 120 and the second portion 404 of the content in different frames or windows of a user interface, as shown in the example 400. Additionally or alternatively, the primary device 102 outputs the second portion 404 of the content 120 as a picture-in-picture frame displayed over the first portion 402 of the content 120.

Notably, the second portion 404 of the content 120 is displayed in the user interface of the primary device 102 as a real time feed. For example, the secondary user 110 can change the second portion 404 of the content 120 displayed on the secondary device 104 using the input devices 130 of the secondary device 104. In real time, the content control module 128 causes a corresponding change to be displayed in the user interface of the primary device 102. Moreover, the first portion 402 of the content 120 is manipulable independently of the second portion 404 of the content 120. In other words, the primary user 108 can manipulate and alter the first portion 402 of the content 120 while concurrently outputting the second portion 404 of the content 120 and without altering second portion 404 of the content 120 output via the secondary device 104.

In one or more implementations, operating the primary device 102 in the remote access mode 406 includes receiving user input, via the primary device 102, to control the second portion 404 of the content 120 being output by the secondary device 104. For example, the content control module 128 receives user input 408 via the input devices 112 of the primary device 102. As shown, the user input 408 is provided to the second portion 404 of the content 120 displayed on the primary device 102. In accordance with the described techniques, the content control module 128 causes a corresponding action to occur at the secondary device 104 in response to the user input 408.

Consider the illustrated example 400 in which the second portion 404 of the content 120 is a streaming application that includes a user interface element selectable to play and pause streaming content. In the example, the primary user 108 provides the user input 408 (e.g., via a touch-sensitive display of the primary device 102) selecting the user interface element of the streaming application. As shown at 410 of FIG. 4B, the user input 408 causes a corresponding action to occur at the secondary device 104, which in this example includes causing the secondary device 104 to play the streaming content. Notably, the user input 408 does not affect the first portion 402 of the content 120 output via the primary device 102.

In one or more implementations, the primary user 108 is a supervisor (e.g., a parent) of the secondary user 110, e.g., a child. Thus, the remote access mode 406 enables the primary user 108 to ensure that the secondary user 110 is not accessing any inappropriate or unpermitted content 120. Additionally or alternatively, the secondary user 110 lacks the technological expertise to access desired content 120. Therefore, the remote access mode 406 enables the primary user 108 to remotely control the secondary device 104 via the primary device 102 to show the secondary user 110 how to access the desired content 120.

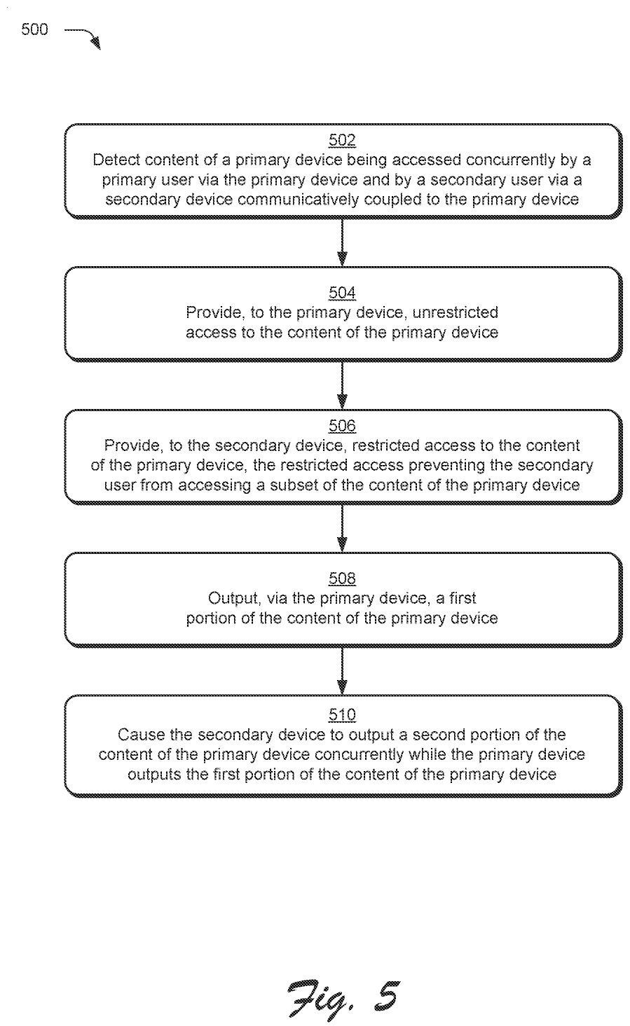

FIG. 5 depicts an example procedure 500 of variable concurrent access to content of a device by multiple devices to provide unrestricted access to a primary device and restricted access to a secondary device. Procedure 500 is carried out by a primary device, such as primary device 102 of FIG. 1, and can be implemented in software, firmware, hardware, or combinations thereof. Procedure 500 is shown as a set of acts and is not limited to the order shown for performing the operations of the various acts.

At 502, content of a primary device is detected as being accessed concurrently by a primary user via the primary device and by a secondary user via a secondary device communicatively coupled to the primary device. By way of example, the access detection module 202 detects the content 120 of the primary device 102 being accessed concurrently via the primary device 102 and the secondary device 104. Further, the access detection module 202 determines that the primary user 108 is accessing the content 120 via the primary device 102 and the secondary user 110 is accessing the content 120 via the secondary device 104. To do so, the access detection module 202 collects the access data 206 from the primary device 102 and/or the secondary device 104 and compares the collected access data 206 to stored access data identifying the primary user 108 and/or the secondary user 110. In at least one example, the access detection module 202 determines that the primary user 108 is accessing the primary device 102 and the secondary user 110 is accessing the secondary device 104 based on sensor data obtained from sensors of the primary device 102 and identifying the primary user and/or sensor data obtained from the sensors of the secondary device 104 and identifying the secondary user 110. Additionally or alternatively, the access detection module 202 determines that the primary user 108 is accessing the primary device 102 and the secondary user 110 is accessing the secondary device 104 based on a wearable device associated with the primary user 108 being closer to the primary device 102 than an additional wearable device associated with the secondary user 110.

At 504, unrestricted access to the content of the primary device is provided to the primary device. By way of example, the access provision module 204 provides the unrestricted access 134 to the primary device 102 permitting the primary user 108 to access the content 120 of the primary device 102 without restriction. While operating the primary device 102 in the unrestricted access mode, the content control module 128 can receive user input via the primary device 102 which specifies the restricted content 122 from which the secondary user 110 is prevented from accessing, as well as the temporal restrictions imposed on the content 120 which the secondary user 110 is permitted to access.

At 506, restricted access to the content of the primary device is provided to the secondary device, the restricted access preventing the secondary user from accessing a subset of the content of the primary device. By way of example, the access provision module 204 provides the restricted access 136 to the secondary device preventing the secondary user 110 from accessing the restricted content 122 of the primary device 102. In the restricted access mode, the content 120 of the primary device 102 that is not included as part of the restricted content 122 is accessible via the secondary device 104. In some implementations, the content 120 that is accessible by the secondary user 110 is subject to temporal restrictions enabling the secondary user 110 to access a portion of the content 120 via the secondary device 104 but only for a specified time limit.

At 508, a first portion of the content of the primary device is output via the primary device. For example, the content control module 128 outputs a first portion of the content 120 via the primary device 102. At 510, a second portion of the content of the primary device is caused to be output by the secondary device concurrently while the primary device outputs the first portion of the content of the primary device. By way of example, the content control module 128 causes the secondary device 104 to output a second portion of the content 120 while the primary device 102 outputs the first portion of the content 120. In some examples, the first portion of the content 120 output via the primary device 102 is a first application of the primary device 102 and the second portion of the content 120 output via the secondary device 104 is a second application of the primary device 102.

While operating the primary device 102 in the unrestricted access mode, the content control module 128 receives user input via the primary device 102 to enter into a remote access mode 406. In the remote access mode 406, the primary device 102 outputs the second portion of the content being output by the secondary device 104, e.g., in addition to outputting the first portion of the content 120. Also in the remote access mode 406, the content control module 128 receives user input via the primary device 102 controlling the second portion of the content 120 being output by the secondary device 104.

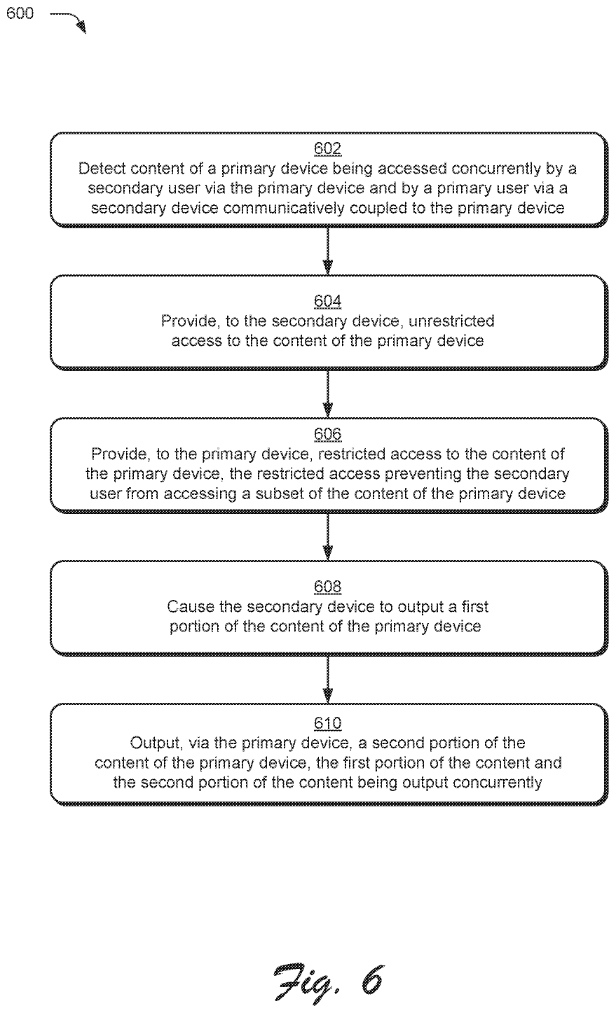

FIG. 6 depicts an example procedure 600 of variable concurrent access to content of a device by multiple devices to provide restricted access to a primary device and unrestricted access to a secondary device. Procedure 600 is carried out by a primary device, such as primary device 102 of FIG. 1, and can be implemented in software, firmware, hardware, or combinations thereof. Procedure 600 is shown as a set of acts and is not limited to the order shown for performing the operations of the various acts.

At 602, content of a primary device is detected as being accessed concurrently by a secondary user via the primary device and by a primary user via a secondary device communicatively coupled to the primary device. By way of example, the access detection module 202 detects the content 120 of the primary device being accessed concurrently via the primary device 102 and the secondary device 104. Further, the access detection module 202 determines that the secondary user 110 is accessing the content 120 via the primary device 102 and the primary user 108 is accessing the content 120 via the secondary device 104. To do so, the access detection module 202 collects the access data 206 from the primary device 102 and/or the secondary device 104 and compares the collected access data 206 to the stored access data identifying the primary user 108 and/or the secondary user 110. In at least one example, the access detection module 202 determines that the secondary user 110 is accessing the primary device 102 and the primary user 108 is accessing the secondary device 104 based on sensor data obtained from sensors of the primary device 102 and identifying the secondary user 110 and/or based on sensor data obtained from sensors of the secondary device 104 and identifying the primary user 108. Additionally or alternatively, the access detection module 202 determines that the secondary user 110 is accessing the primary device 102 and the primary user 108 is accessing the secondary device 104 based on a wearable device associated with the secondary user 110 being closer to the primary device 102 than an additional wearable device associated with the primary user 108.

At 604, unrestricted access to the content of the primary device is provided to the secondary device. By way of example, the access provision module 204 provides the unrestricted access 134 to the secondary device 104 permitting the primary user 108 to access the content 120 of the primary device 102 without restriction. While operating the secondary device 104 in the unrestricted access mode, the content control module 128 can receive user input via the secondary device 104 specifying the restricted content 122 from which the secondary user 110 is prevented from accessing, as well as the temporal restrictions imposed on the content 120 which the secondary user 110 is permitted to access.

At 606, restricted access to the content of the primary device is provided to the primary device, the restricted access preventing the secondary user from accessing a subset of the content of the primary device. By way of example, the access provision module 204 provides the restricted access 136 to the primary device 102 preventing the secondary user 110 from accessing the restricted content 122 of the primary device 102. In the restricted access mode, the content 120 of the primary device 102 that is not included as part of the restricted content 122 is accessible via the primary device 102. In some implementations, the content 120 that is accessible by the secondary user 110 is subject to temporal restrictions enabling the secondary user 110 to access a portion of the content 120 via the primary device 102 but only for a specified time limit.

At 608, a first portion of the content of the primary device is caused to be output by the secondary device. By way of example, the content control module 128 causes the secondary device 104 to output a first portion of the content 120. At 610, a second portion of the content of the primary device is output via the primary device, the first portion of the content and the second portion of the content being output concurrently. For example, the content control module 128 outputs a second portion of the content 120 via the primary device 102 while the secondary device 104 outputs the first portion of the content 120. In some examples, the first portion of the content 120 output via the secondary device 104 is a first application of the primary device 102 and the second portion of the content 120 output via the primary device 102 is a second application of the primary device 102.

While operating the secondary device 104 in the unrestricted access mode, the content control module 128 receives user input via the secondary device 104 to enter into a remote access mode 406. In the remote access mode 406, the secondary device 104 outputs the second portion of the content 120 being output by the primary device 102, e.g., in addition to outputting the first portion of the content 120. Also in the remote access mode 406, the content control module 128 receives user input via the secondary device 104 to control the second portion of the content being output by the primary device 102.

FIG. 7 illustrates various components of an example device 700 that can implement aspects of variable concurrent access to content of a device by multiple devices. The example device 700 can be implemented as any of the devices described with reference to the previous FIGS. 1-6, such as any type of mobile device, mobile phone, mobile device, wearable device, tablet, computing, communication, entertainment, gaming, media playback, and/or other type of electronic device. For example, the primary device 102 and/or the secondary device 104 as shown and described with reference to FIGS. 1-6 may be implemented as the example device 700. In a wearable device implementation, the device may include any one or combination of a watch, armband, wristband, bracelet, glove or pair of gloves, glasses, jewelry items, clothing items, any type of footwear or headwear, and/or other types of wearables.

The device 700 includes communication transceivers 702 that enable wired and/or wireless communication of device data 704 with other devices. The device data 704 can include any of device identifying data, device location data, wireless connectivity data, and wireless protocol data. Additionally, the device data 704 can include any type of audio, video, and/or image data. Example communication transceivers 702 include wireless personal area network (WPAN) radios compliant with various IEEE 1002.15 (Bluetooth™) standards, wireless local area network (WLAN) radios compliant with any of the various IEEE 1002.11 (Wi-Fi™) standards, wireless wide area network (WWAN) radios for cellular phone communication, wireless metropolitan area network (WMAN) radios compliant with various IEEE 1002.16 (WiMAX™) standards, and wired local area network (LAN) Ethernet transceivers for network data communication.

The device 700 can also include various, different types of data input/output (I/O) interfaces 706, such as data network interfaces that provide connection and/or communication links between the devices, data networks, and other devices. The I/O interfaces 706 can be used to couple the device to any type of components, peripherals, and/or accessory devices, such as a computer input devices that may be integrated with the example device 700. The I/O interfaces 706 may also include data input ports via which any type of data, information, media content, communications, messages, and/or inputs can be received, such as user inputs to the device, as well as any type of audio, video, image, graphics, and/or electronic data received from any content and/or data source. The data input ports may include USB ports, coaxial cable ports, and other serial or parallel connectors (including internal connectors) for flash memory, DVDs, CDs, and the like. These data input ports may be used to couple the device 700 to any type of components, peripherals, or accessories such as microphones and/or cameras.

The device 700 includes a processing system 708 of one or more processors (e.g., any of microprocessors, controllers, and the like) and/or a processor and memory system implemented as a system-on-chip (SoC) that processes computer-executable instructions. The processor system 708 may be implemented at least partially in hardware, which can include components of an integrated circuit or on-chip system, an application-specific integrated circuit (ASIC), a field-programmable gate array (FPGA), a complex programmable logic device (CPLD), and other implementations in silicon and/or other hardware. Additionally or alternatively, the device can be implemented with any one or combination of software, hardware, firmware, or fixed logic circuitry that is implemented in connection with processing and control circuits, which are generally identified at 710. The device 700 may further include any type of a system bus or other data and command transfer system that couples the various components within the device. A system bus can include any one or combination of different bus structures and architectures, as well as control and data lines.

The device 700 also includes computer-readable storage memory 712 (e.g., memory devices) that enable data storage, such as data storage devices that can be accessed by a computing device, and that provide persistent storage of data and executable instructions (e.g., software applications, programs, functions, and the like). Examples of the computer-readable storage memory 712 include volatile memory and non-volatile memory, fixed and removable media devices, and any suitable memory device or electronic data storage that maintains data for computing device access. The computer-readable storage memory can include various implementations of random access memory (RAM), read-only memory (ROM), flash memory, and other types of storage media in various memory device configurations. The device 700 may also include a mass storage media device.

The computer-readable storage memory 712 provides data storage mechanisms to store the device data 704, other types of information and/or data, and various device applications 714 (e.g., software applications). For example, an operating system 716 can be maintained as software instructions with a memory device and executed by the processing system 708. The device applications may also include a device manager, such as any form of a control application, software application, signal-processing and control module, code that is native to a particular device, a hardware abstraction layer for a particular device, and so on. Computer-readable storage memory 712 represents media and/or devices that enable persistent and/or non-transitory storage of information in contrast to mere signal transmission, carrier waves, or signals per se. Computer-readable storage memory 712 do not include signals per se or transitory signals.

In this example, the device 700 includes a content control module 718 that implements aspects of the techniques discussed herein and may be implemented with hardware components and/or in software as one of the device applications 714. For example, the content control module 718 can be implemented as the content control module 128 described in detail above. In implementations, the content control module 718 may include independent processing, memory, and logic components as a computing and/or electronic device integrated with the device 700.

In this example, the example device 700 also includes sensors 722. The sensors 722 are representative of functionality to detect various physical and/or logical phenomena in relation to the example device 700, such as motion, light, image detection and recognition, time and date, position, location, proximity, presence, touch detection, sound, temperature, and so forth. Examples of the sensors include hardware and/or logical sensors such as an accelerometer, a gyroscope, a camera, a microphone, a clock, biometric sensors, touch input sensors, position sensors, environmental sensors (e.g., for temperature, pressure, humidity, and so on), proximity sensors, presence sensors, geographical location information sensors (e.g., Global Positioning System (GPS) functionality), and so forth.

The device 700 also includes a wireless module 724, which is representative of functionality to perform various wireless communication tasks. For instance, for the primary device 102 and/or the secondary device 104, the wireless module 724 can be leveraged to scan for and detect wireless networks, as well as negotiate wireless connectivity to wireless networks for the primary device 102 and/or the secondary device 104. Additionally or alternatively, the wireless module 724 can enable direct device-to-device wireless connectivity between the primary device 102 and the secondary device 104. The device 700 can also include one or more power sources 726, such as when the device is implemented as a mobile device. The power sources 726 may include a charging and/or power system, and can be implemented as a flexible strip battery, a rechargeable battery, a charged super-capacitor, and/or any other type of active or passive power source.

The device 700 also includes an audio and/or video processing system 728 that generates audio data for an audio system 730 and/or generates display data for a display system 732. The audio system and/or the display system may include any devices that process, display, and/or otherwise render audio, video, display, and/or image data. Display data and audio signals can be communicated to an audio component (e.g., a speaker, headset, earbuds) and/or to a display component via an RF (radio frequency) link, S-video link, HDMI (high-definition multimedia interface), composite video link, component video link, DVI (digital video interface), analog audio connection, or other similar communication link, such as media data port 734. In implementations, the audio system and/or the display system are integrated components of the example device. Alternatively, the audio system and/or the display system are external, peripheral components to the example device.

Although implementations of variable concurrent access to content of a device by multiple devices have been described in language specific to features and/or methods, the subject of the appended claims is not necessarily limited to the specific features or methods described. Rather, the features and methods are disclosed as example implementations, and other equivalent features and methods are intended to be within the scope of the appended claims. Further, various different examples are described and it is to be appreciated that each described example can be implemented independently or in connection with one or more other described examples. Additional aspects of the techniques, features, and/or methods discussed herein relate to one or more of the following:
In some aspects, the techniques described herein relate to a method, comprising: detecting content of a primary device being accessed concurrently by a primary user via the primary device and by a secondary user via a secondary device communicatively coupled to the primary device; providing, to the primary device, unrestricted access to the content of the primary device; providing, to the secondary device, restricted access to the content of the primary device, the restricted access preventing the secondary user from accessing a subset of the content of the primary device; outputting, via the primary device, a first portion of the content of the primary device; and causing the secondary device to output a second portion of the content of the primary device concurrently while the primary device outputs the first portion of the content of the primary device.

In some aspects, the techniques described herein relate to a method, wherein providing the unrestricted access includes outputting, via the primary device, the second portion of the content being output by the secondary device.

In some aspects, the techniques described herein relate to a method, wherein providing the unrestricted access includes receiving, via the primary device, user input controlling the second portion of the content being output by the secondary device.

In some aspects, the techniques described herein relate to a method, wherein the first portion of the content corresponds to content of a first application of the primary device and the second portion of the content corresponds to content of a second application of the primary device.

In some aspects, the techniques described herein relate to a method, further comprising determining that the primary user is accessing the content of the primary device based on sensor data obtained from one or more sensors of the primary device.

In some aspects, the techniques described herein relate to a method, further comprising determining that the primary user is accessing the content of the primary device based on a wearable device associated with the primary user being closer to the primary device than an additional wearable device associated with the secondary user.

In some aspects, the techniques described herein relate to a method, further comprising receiving, via the primary device, user input specifying the subset of the content that the secondary user is prevented from accessing.

In some aspects, the techniques described herein relate to a method, further comprising: detecting the content of the primary device being accessed concurrently by the primary user via the secondary device and by the secondary user via the primary device; providing, to the secondary device, the unrestricted access to the content of the primary device; and providing, to the primary device, the restricted access to the content of the primary device.

In some aspects, the techniques described herein relate to a primary device comprising: a content control module, implemented at least partially in hardware of the primary device, to: detect content of the primary device being accessed concurrently by a primary user via the primary device and by a secondary user via a secondary device communicatively coupled to the primary device; provide, to the primary device, unrestricted access to the content of the primary device; provide, to the secondary device, restricted access to the content of the primary device, the restricted access preventing the secondary user from accessing a subset of the content of the primary device; output, via the primary device, a first portion of the content of the primary device; and cause the secondary device to output a second portion of the content of the primary device concurrently while the primary device outputs the first portion of the content of the primary device.

In some aspects, the techniques described herein relate to a primary device, wherein to provide the unrestricted access, the content control module is configured to output, via the primary device, the second portion of the content being output by the secondary device.

In some aspects, the techniques described herein relate to a primary device, wherein to provide the unrestricted access, the content control module is configured to receive, via the primary device, user input controlling the second portion of the content being output by the secondary device.

In some aspects, the techniques described herein relate to a primary device, wherein the first portion of the content corresponds to content of a first application of the primary device and the second portion of the content corresponds to content of a second application of the primary device.

In some aspects, the techniques described herein relate to a primary device, wherein the content control module is further configured to determine that the primary user is accessing the content of the primary device based on one or more of: sensor data obtained from one or more sensors of the primary device; and a comparison of wearable device proximity data obtained from a wearable device associated the primary user to additional wearable device proximity data obtained from an additional wearable device associated with the secondary user.

In some aspects, the techniques described herein relate to a method comprising: detecting content of a primary device being accessed concurrently by a secondary user via the primary device and by a primary user via a secondary device communicatively coupled to the primary device; providing, to the secondary device, unrestricted access to the content of the primary device; providing, to the primary device, restricted access to the content of the primary device, the restricted access preventing the secondary user from accessing a subset of the content of the primary device; causing the secondary device to output a first portion of the content of the primary device; and outputting, via the primary device, a second portion of the content of the primary device, the first portion of the content and the second portion of the content being output concurrently.

In some aspects, the techniques described herein relate to a method, wherein providing the unrestricted access includes: communicating, to the secondary device, the second portion of the content being output by the primary device; and causing the secondary device to output the second portion of the content.

In some aspects, the techniques described herein relate to a method, wherein providing the unrestricted access includes: receiving, from the secondary device, user input controlling the second portion of the content being output by the primary device; and adjusting the content being output by the primary device in accordance with the user input.

In some aspects, the techniques described herein relate to a method, wherein the first portion of the content corresponds to content of a first application of the primary device and the second portion of the content corresponds to content of a second application of the primary device.

In some aspects, the techniques described herein relate to a method, further comprising determining that the secondary user is accessing the content of the primary device based on sensor data obtained from one or more sensors of the primary device.

In some aspects, the techniques described herein relate to a method, further comprising determining that the secondary user is accessing the content of the primary device based on a wearable device associated with the secondary user being closer to the primary device than an additional wearable device associated with the primary user.

In some aspects, the techniques described herein relate to a method, further comprising receiving, from the secondary device, user input specifying the subset of the content that the secondary user is prevented from accessing.

1. A method comprising:
detecting content of a primary device being accessed concurrently by a primary user via the primary device and by a secondary user via a secondary device communicatively coupled to the primary device;
providing, to the primary device, unrestricted access to the content of the primary device;
providing, to the secondary device, restricted access to the content of the primary device, the restricted access preventing the secondary user from accessing a subset of the content of the primary device;
outputting, via the primary device, a first portion of the content of the primary device; and
causing the secondary device to output a second portion of the content of the primary device concurrently while the primary device outputs the first portion of the content of the primary device.

2. The method of claim 1, wherein providing the unrestricted access includes outputting, via the primary device, the second portion of the content being output by the secondary device.

3. The method of claim 1, wherein providing the unrestricted access includes receiving, via the primary device, user input controlling the second portion of the content being output by the secondary device.

4. The method of claim 1, wherein the first portion of the content corresponds to content of a first application of the primary device and the second portion of the content corresponds to content of a second application of the primary device.

5. The method of claim 1, further comprising determining that the primary user is accessing the content of the primary device based on sensor data obtained from one or more sensors of the primary device.

6. The method of claim 1, further comprising determining that the primary user is accessing the content of the primary device based on a wearable device associated with the primary user being closer to the primary device than an additional wearable device associated with the secondary user.

7. The method of claim 1, further comprising receiving, via the primary device, user input specifying the subset of the content that the secondary user is prevented from accessing.

8. The method of claim 1, further comprising:
detecting the content of the primary device being accessed concurrently by the primary user via the secondary device and by the secondary user via the primary device;
providing, to the secondary device, the unrestricted access to the content of the primary device; and
providing, to the primary device, the restricted access to the content of the primary device.

9. A primary device comprising:
a content control module, implemented at least partially in hardware of the primary device, to:
detect content of the primary device being accessed concurrently by a primary user via the primary device and by a secondary user via a secondary device communicatively coupled to the primary device;
provide, to the primary device, unrestricted access to the content of the primary device;
provide, to the secondary device, restricted access to the content of the primary device, the restricted access preventing the secondary user from accessing a subset of the content of the primary device;
output, via the primary device, a first portion of the content of the primary device; and
cause the secondary device to output a second portion of the content of the primary device concurrently while the primary device outputs the first portion of the content of the primary device.

10. The primary device of claim 9, wherein to provide the unrestricted access, the content control module is configured to output, via the primary device, the second portion of the content being output by the secondary device.

11. The primary device of claim 9, wherein to provide the unrestricted access, the content control module is configured to receive, via the primary device, user input controlling the second portion of the content being output by the secondary device.

12. The primary device of claim 9, wherein the first portion of the content corresponds to content of a first application of the primary device and the second portion of the content corresponds to content of a second application of the primary device.

13. The primary device of claim 9, wherein the content control module is further configured to determine that the primary user is accessing the content of the primary device based on one or more of:
sensor data obtained from one or more sensors of the primary device; and
a comparison of wearable device proximity data obtained from a wearable device associated with the primary user to additional wearable device proximity data obtained from an additional wearable device associated with the secondary user.

14. A method comprising:
detecting content of a primary device being accessed concurrently by a secondary user via the primary device and by a primary user via a secondary device communicatively coupled to the primary device;
providing, to the secondary device, unrestricted access to the content of the primary device;
providing, to the primary device, restricted access to the content of the primary device, the restricted access preventing the secondary user from accessing a subset of the content of the primary device;
causing the secondary device to output a first portion of the content of the primary device; and
outputting, via the primary device, a second portion of the content of the primary device, the first portion of the content and the second portion of the content being output concurrently.

15. The method of claim 14, wherein providing the unrestricted access includes:
communicating, to the secondary device, the second portion of the content being output by the primary device; and
causing the secondary device to output the second portion of the content.

16. The method of claim 14, wherein providing the unrestricted access includes:
receiving, from the secondary device, user input controlling the second portion of the content being output by the primary device; and
adjusting the content being output by the primary device in accordance with the user input.

17. The method of claim 14, wherein the first portion of the content corresponds to content of a first application of the primary device and the second portion of the content corresponds to content of a second application of the primary device.

18. The method of claim 14, further comprising determining that the secondary user is accessing the content of the primary device based on sensor data obtained from one or more sensors of the primary device.

19. The method of claim 14, further comprising determining that the secondary user is accessing the content of the primary device based on a wearable device associated with the secondary user being closer to the primary device than an additional wearable device associated with the primary user.

20. The method of claim 14, further comprising receiving, from the secondary device, user input specifying the subset of the content that the secondary user is prevented from accessing.
